(19) United States
(12) Patent Application Publication
(10) Pub. No.: US 2026/0184260 A1
(43) Pub. Date: Jul. 2, 2026

(54) CAMERA INPUT BUFFER SIZE DETERMINATION BASED ON TOWED-TRAILER CHARACTERISTICS

(71) Applicant: TOYOTA MOTOR NORTH AMERICA, INC., Plano, TX (US)

(72) Inventor: Raja Manas Macherla, Ypsilanti, MI (US)

(73) Assignees: TOYOTA MOTOR NORTH AMERICA, INC., Plano, TX (US); TOYOTA JIDOSHA KABUSHIKI KAISHA, Aichi-ken (JP)

(21) Appl. No.: 19/005,609

(22) Filed: Dec. 30, 2024

(51) Int. Cl. H04N 7/18; B60R 1/26; H04N 23/80

(52) U.S. Cl. CPC B60R 1/26; H04N 23/80; B60R 2300/105; B60R 2300/303

(57) ABSTRACT

In a towing configuration, a trailer is towed behind a vehicle and obstructs a portion of the view of wired onboard vehicle cameras. To avoid blind-spots created by the trailer, wireless camera systems are positioned on a rear portion of the trailer and send additional images to the vehicle that are stitched together with the images generated by the onboard vehicle cameras. Based on the length of the trailer, the latency of the image capture system changes, which makes stitching together images generated by the vehicle cameras and the trailer cameras difficult. Systems and methods for a dynamically updatable buffer size in an image capture system, including the vehicle and tailer cameras, to compensate for latency in the system are disclosed. The size of the buffer is dynamically updated based on the length of the trailer to store enough images to compensate for the latency in the system.

### FIELD OF THE DISCLOSURE

The present disclosure relates, in general, to systems and methods for displaying images from two or more cameras associated with a vehicle and a trailer towed behind the vehicle in an advanced driver assistance system (“ADAS”), and more particularly, to systems and methods for a variable camera buffer size that is dynamically updatable based on the towed trailer characteristics, including dimensions, or a distance between the vehicle and a camera positioned on the towed trailer.

### BACKGROUND

Cameras associated with advanced driver assistance systems (“ADAS”) in a vehicle are used to provide enhanced visibility and object recognition. A vehicle may have multiple cameras positioned around the vehicle to provide panoramic or three-dimensional views of the environment surrounding the vehicle.

In towing applications, where the vehicle is towing a trailer behind the vehicle, the trailer can obstruct rear-facing cameras positioned on the vehicle. Some trailers are now equipped with additional rear-facing cameras positioned on the trailer that can communicate additional rear-facing images to the vehicle. Rear-facing images generated by the vehicle cameras can be combined with the additional rear-facing images generated by the trailer cameras to provide an operator of the vehicle with a rear-view video feed that is unobstructed by the trailer. The additional trailer cameras may be wireless camera systems that provide more versatility during installation and reduce the incidence of compatibility issues with the vehicle ADAS.

Based on the distance between the trailer cameras and the vehicle cameras, the latency of the entire camera system, including the trailer cameras and the vehicle cameras, changes. This is particularly relevant in applications where wireless camera systems are used. For example, in scenarios where a long trailer is being towed by the vehicle, the latency of the entire camera system is increased due to the increased distance camera signals from the trailer cameras must travel to reach a controller associated with the vehicle ADAS. Typically, a memory of the controller associated with the vehicle ADAS includes a fixed number of camera buffers. As a result, multi-camera perception tasks, such as combining images from the trailer cameras with images from the vehicle cameras to provide a smooth and accurate video feed that is free of blind-spots, is difficult. The present disclosure addresses one or more shortcomings of conventional systems.

### BRIEF DESCRIPTION OF THE DRAWINGS

FIG. 1 illustrates an image capture system including a vehicle towing a trailer, according to one or more embodiments;

FIG. 2 illustrates components of the image capture system of FIG. 1 associated with the vehicle, including a central processing unit (“CPU”), a graphical user interface (“GUI”), and a plurality of cameras, according to one or more embodiments;

FIG. 3A illustrates execution of a distance-based buffer size determination module 200, a distance-based buffer size adjustment module 205, and an image receipt module 210 of the CPU of FIG. 2, according to one or more embodiments;

FIG. 3B illustrates execution of an image shift module of the CPU of FIG. 2, according to one or more embodiments;

FIG. 4 illustrates a stitched image displayed on the GUI of FIG. 2, according to one or more embodiments; and

FIG. 5 illustrates a method of utilizing a variable buffer size in the image capture system of FIG. 1 with a first camera associated with the vehicle and a second camera associated with the trailer to compensate for latency due to a distance of the second camera from the vehicle, according to one or more embodiments.

### DETAILED DESCRIPTION

The following disclosure provides many different embodiments. Specific examples of components and arrangements are described below to simplify the present disclosure. These are, of course, merely examples and are not intended to be limiting. In addition, the present disclosure may repeat reference numerals and/or letters in the various embodiments. This repetition is for the purpose of simplicity and clarity and does not in itself dictate a relationship between the various embodiments and/or configurations discussed.

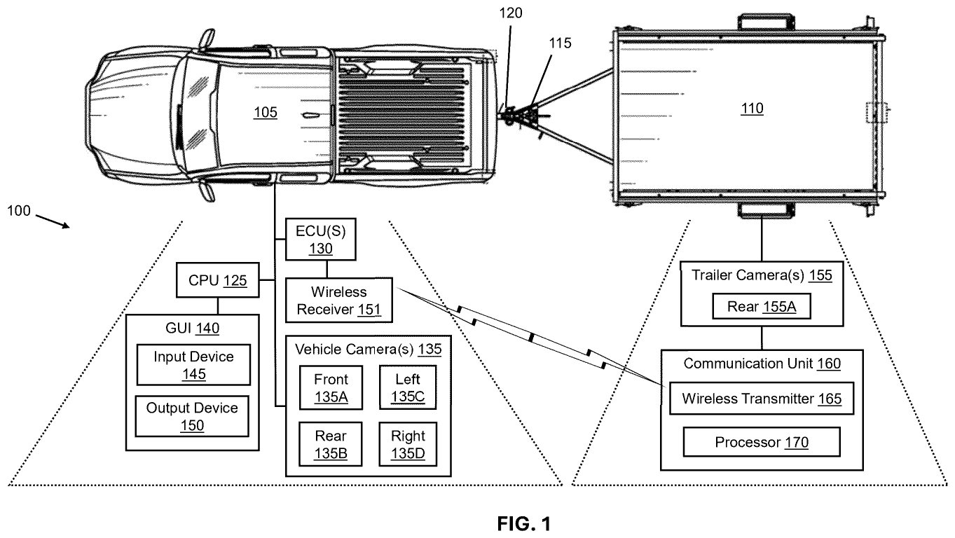

FIG. 1 illustrates an image capture system 100 for use with a vehicle 105 and a trailer 110. In the embodiment shown, vehicle 105 and trailer 110 are arranged in a towing configuration such that trailer 110 is towed behind vehicle 105. Trailer 110 is mechanically coupled with vehicle 105 via a tow hitch 115. In one or more embodiments, trailer 110 may also be electrically coupled with vehicle 105 via one or more electrical connections 120.

Vehicle 105 includes a central processing unit (“CPU”) 125, an electronic control unit (“ECU”) 130, and one or more vehicle cameras 135. CPU 125, ECU 130, and vehicle cameras 135 are connected and in communication with each other via wired or wireless communications. CPU 125 is also connected and in communication with a graphical user interface (“GUI”) 140, which includes an input device 145 and an output device 150. The input device may also include buttons, knobs, switches, or other input features as a part of the GUI or in addition to the GUI. In one or more embodiments, a user may provide inputs to CPU 125, and CPU 125 may display outputs to the user, via a window that is displayed on GUI 140. In one or more embodiments, input device 145 may also include a microphone and output device 150 may also include a speaker for audio. ECU 130 is also connected to and in communication with a wireless receiver 151 that may include, for example, an antenna. In one or more embodiments, vehicle cameras 135 may include any one or more of a front camera 135A, a rear camera 135B, a left-side camera 135C, and a right-side camera 135D. In one or more embodiments, the user may select, via input device 145 of GUI 140, any one or more of the vehicle cameras 135 to display, via output device 150 of GUI 140, individual camera views or a panoramic view (or three-dimensional view) including a combination of the individual camera views.

Trailer 110 includes one or more trailer cameras 155, including rear camera 155A, connected to and in communication with a communication unit 160. Communication unit 160 includes a wireless transmitter 165 including for example an antenna, and a processor 170. Communication unit 160 is configured to communicate, using wireless transmitter 165, images generated by trailer camera 155 to wireless receiver 151 of vehicle 105. In one or more embodiments, communication unit 160 communicates the images to wireless receiver 151 over a wireless communication network, such as, for example, WIFI. In one or more embodiments, the wireless communication network may be associated with vehicle 105, such as, for example, a vehicle WIFI network. In one or more embodiments, trailer cameras 155 may be wireless cameras that connect or otherwise communicate with vehicle 105 through an onboard wireless camera ECU. It should be apparent that the receivers and the transmitters described herein may be transceivers and that two-way communication using transceivers or additional receivers and transmitters could be used to facilitate the two-way communications between the vehicle and the trailer. Other communication protocols may be used.

In operation, in one or more embodiments, each vehicle camera 135 may be positioned about vehicle 105, including rear camera 135B positioned at a rear portion of vehicle 105 and generating a plurality of vehicle rear-view images. In one or more embodiments, when vehicle 105 and trailer 110 are in the towing configuration shown in FIG. 1, at least a portion of each vehicle rear-view image generated by rear camera 135B is obstructed by trailer 110. This limits the visibility of the driver as trailer 110 is therefore obstructing the view of an operator of vehicle 105.

To mitigate this condition and provide the operator of vehicle 105 with an unobstructed view of the environment surrounding vehicle 105 and trailer 110, one or more trailer cameras 155 may be installed on trailer 110 and communicate images to ECU 130 and CPU 125 of vehicle 105. In one or more embodiments, trailer cameras 155 includes rear camera 155A positioned on a rear portion of trailer 110 and generating trailer rear-view images.

In one or more embodiments, trailer cameras 155 may be wired cameras that are integrated with trailer 110, and which may be in communication with ECU 130 via electrical connections 120. In one or more embodiments, trailer cameras 155 may be wireless cameras that may be retrofitted onto trailer 110. Wireless cameras provide a user or operator with greater flexibility to position the cameras as desired. For example, the wireless cameras may be positioned on trailer 110 in a position where the wireless cameras will be able to generate images that supplement the obstructed images generated by vehicle cameras 135 to mitigate the effect of the obstruction. In this regard, trailer cameras 155 may be positioned in a similar orientation to vehicle cameras 135 that are obstructed by trailer 110 in order to supplement the images generated by those obstructed cameras.

Here, the vehicle rear-view images generated by rear camera 135B of vehicle 105 are obstructed by trailer 110. Thus, rear camera 155A of trailer 110 is positioned at a rear portion of trailer 110 in a similar orientation to rear camera 135B in order to supplement the view of rear camera 135B. As rear camera 155A generates trailer rear-view images, communication unit 160, using wireless transmitter 165, transmits the trailer rear-view images to ECU 130, via wireless receiver 151. In one or more embodiments, where rear camera 155A is wired, the images are transmitted via wired connection. The images are then sent from the ECU to the CPU for processing. Using CPU 125, the trailer rear-view images generated by rear camera 155A are stitched together, or combined, with the vehicle rear-view images generated by rear camera 135B and subsequently displayed via output device 150 of GUI 140. However, the greater the distance between rear camera 155A and vehicle 105, the greater the camera latency, i.e., the greater the time delay between the point in time when rear camera 155A generates trailer rear-view images and the point in time when those trailer rear-view images reach vehicle 105, which makes stitching together the vehicle rear-view images and the trailer rear-view images to create a smooth and accurate combined video feed difficult. The present disclosure provides systems and methods that overcome these difficulties.

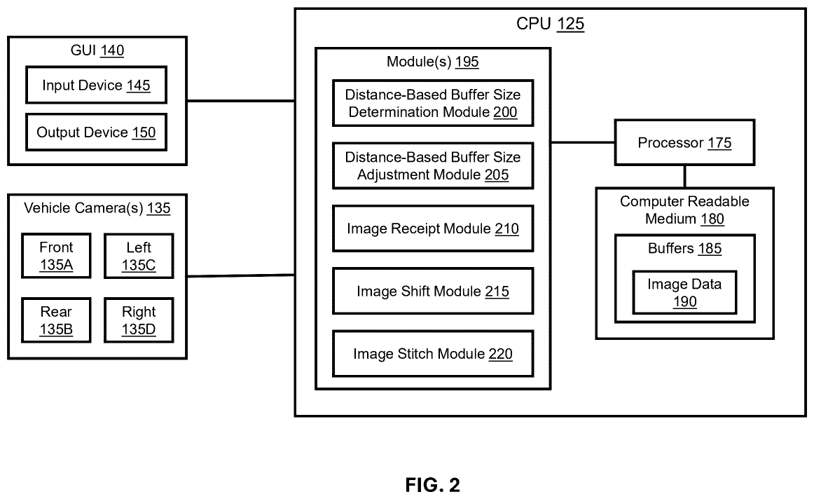

FIG. 2 illustrates CPU 125 of vehicle 105 in further detail. As shown, CPU 125 includes a processor 175 and a computer readable medium 180 operably coupled thereto. In one or more embodiments, computer readable medium 180 is a non-transitory computer readable medium. Instructions accessible to, and executable by, processor 175 are stored on computer readable medium 180. One or more buffers 185 are also stored in computer readable medium 180. Each buffer 185 is configured to store image data 190 associated with the images generated by vehicle cameras 135 and trailer cameras 155. The number of buffers 185, or also referred to as the size of buffer 185, is dynamically updatable or adjustable to account for the latency of image capture system 100.

A plurality of modules 195 are also operably coupled to and accessible and executable by processor 175. In some implementations, these are software programs that perform certain tasks. In one or more embodiments, plurality of modules 190 may include: a distance-based buffer size determination module 200; a distance-based buffer size adjustment module 205; an image receipt module 210; an image shift module 215; and an image stitch module 220.

As discussed above, the latency of image capture system 100 changes depending on the distance between trailer cameras 155 and vehicle 105. In the embodiments shown, the distance between rear camera 155A and vehicle 105 is directly related to the length or size of trailer 110. Because trailer 110 is obstructing rear camera 135B of vehicle 105, rear camera 155A of trailer 110 is positioned at a rear portion of trailer 110 in order to generate trailer rear-view images that supplement vehicle rear-view images. Thus, the distance between rear camera 155A and vehicle 105 is approximately the length of trailer 110.

Distance-based buffer size determination module 200 is executable by processor 175 to determine a size of buffer 185 required to account for the latency introduced into image capture system 100 based on the length of trailer 110, which, in this example embodiment, is approximately equivalent to the distance between rear camera 155A and vehicle 105. To determine the size of buffer 185 required, CPU 125 receives an input associated with the dimensions of trailer 110 from input device 145 of GUI 140 or other input device. In one or more embodiments, a user of vehicle 105 or trailer 110 may manually input the dimensions of trailer 110, including the length of trailer 110, which are accessible to CPU 125, via input device 145 of GUI 140. In one or more embodiments, a user of vehicle 105 or trailer 110 may manually input the distance between rear camera 155A and vehicle 105, which is accessible to CPU 125, via input device 145 of GUI 140. In one or more embodiments, the dimensions of trailer 110 may be automatically communicated to CPU 125 via wireless communication, such as WIFI, or via wired communication through electrical connections 120 when trailer 110 is connected to vehicle 105. In one or more embodiments, the dimensions of trailer 110 may be downloaded by CPU 125 via internet or online length computation. In one or more embodiments, CPU 125 may utilize vehicle cameras 135 to obtain the dimensions of trailer 110 via object recognition programs or modules.

Based on the dimensions, including length, of trailer 110, or based on the distance between rear camera 155A and vehicle 105, and using distance-based buffer size determination module 200, CPU 125 is able to determine the size of buffer 185 required to store a sufficient number of vehicle rear-view images generated by rear camera 135B to account for the delay between the point in time when the trailer rear-view images are generated by rear camera 155A and the point in time when the trailer rear-view images are received by vehicle 105.

In one or more embodiments, the relationship between the distance between rear camera 155A and vehicle 105 and the size of buffer 185 required is linear. In one or more embodiments, the relationship between the distance between rear camera 155A and vehicle 105 and the size of buffer 185 required is non-linear. In one or more embodiments, the size of buffer 185 required to account for the latency in image capture system 100 may be determined using computer logic. In one or more embodiments, the size of buffer 185 required to account for the latency in image capture system 100 may be determined using a machine learning model.

In one or more embodiments, the relationship between the length of trailer 110 and the size of buffer 185 may be determined experimentally for a plurality of different trailer sizes and stored in a databased, which may then be used to determine the buffer size required for a given application. In one or more embodiments, distance-based buffer size determination module 200 may determine the size of buffer 185 required once the trailer camera 155 is connected and begins transmitting images to vehicle 105. For example, during operation, rear camera 135B and rear camera 155A may begin generating respective rear-view images at the same time; however, due to the additional distance the signals associated with the trailer rear-view images generated by rear camera 155A must travel to reach vehicle 105, the trailer rear-view images will be delayed relative to the vehicle rear-view images. Depending on the frame rates of rear camera 135B and rear camera 155A, and depending on the distance between rear camera 155A and vehicle 105, buffer 185 will store a first vehicle rear-view image and a certain number of subsequent vehicle rear-view images until a first trailer rear-view image, which was generated at the same point in time as the first vehicle rear-view image, is received by vehicle 105. The number of vehicle rear-view images that buffer 185 is required to store before receiving the first trailer rear-view image is equal the number of buffers 185, or corresponds to the size of buffer 185, required to account for the latency in image capture system 100.

In one or more embodiments, upon initiation of image capture system 100, and once image data 190 begins to be stored in buffer 185 of computer readable medium 180, the number of buffers 185, or the size of buffer 185, can be continuously increased in real-time to store as many vehicle rear-view images that are generated during the delay between the point in time when rear camera 155A generates trailer rear-view images and the point in time when those trailer rear-view images reach vehicle 105. This can be performed for the plurality of different trailer sizes to establish a relationship that can be used in conjunction with distance-based buffer size determination module 200 to determine the size of buffer 185 required for a give trailer size. In one or more embodiments, this real-time adjustment of the buffer size may only be utilized for establishing the relationship between trailer length and required buffer size. In one or more embodiments, distance-based buffer size determination module 200 may determine the size of buffer required for use with a given trailer length based on an input of the length of trailer 110 before trailer 110 is connected to vehicle 105.

Distance-based buffer size adjustment module 205 is then used to adjust the size of buffer 185 based on the determination made using distance-based buffer size determination module 200. In one or more embodiments, adjustment of the size of buffer 185 includes increasing the number of buffers 185 stored in computer readable medium 180. In one or more embodiments, adjustment of the size of buffer 185 includes increasing the number of images or the amount of image data that is able to be stored in buffer 185. In one or more embodiments, distance-based buffer size adjustment module 205 may be executed after distance-based buffer size determination module 200 is executed. In one or more embodiments, distance-based buffer size adjustment module 205 may be executed simultaneously with distance-based buffer size determination module 200.

In one or more embodiments, distance-based buffer size determination module 200 and distance-based buffer size adjustment module 205 may be executed simultaneously and in real-time. In one or more embodiments, an initial buffer size determination may be made and implemented; however, during operation, such as when vehicle 105 is actively towing trailer 110, distance-based buffer size determination module 200 and distance-based buffer size adjustment module 205 may be continuously executed simultaneously and in real-time such that the number of buffers 185, or the size of buffer 185, can be continuously increased in real-time to store as many vehicle rear-view images that are generated during the delay between the point in time when rear camera 155A generates trailer rear-view images and the point in time when those trailer rear-view images reach vehicle 105. Continuously executing these modules while vehicle 105 is towing trailer 110 allows the size of buffer 185 to be continuously adjusted in real-time to account for changes in the latency of image capture system 100. For example, while vehicle 105 is towing trailer 110, the delay between the point in time when rear camera 155A generates trailer rear-view images and the point in time when those trailer rear-view images reach vehicle 105 may change due to environmental conditions, physical obstacles, and interference from other devices. Continuously executing modules 195 allows image capture system 100 to account for these changes in latency so that a clear, cohesive, and accurate stitched image can be rendered.

Image receipt module 210 is used to collect image data 190 from vehicle cameras 135 and trailer cameras 155. Image data 190 includes data associated with vehicle rear-view images generated by rear camera 135B and trailer rear-view images generated by rear camera 155A. Image data 190 is then stored in buffer 185 in computer readable medium 180. In one or more embodiments, image receipt module 210 may be executed after distance-based buffer size determination module 200 and distance-based buffer size adjustment module 205 have been executed. In one or more embodiments, image receipt module 210 may be executed simultaneously with distance-based buffer size determination module 200 and distance-based buffer size adjustment module 205.

Image shift module 215 is used to shift the vehicle rear-view images or the trailer rear-view images stored in buffer 185 such that each vehicle rear-view image corresponds to a respective trailer rear-view image that was generated at the same point in time. In one or more embodiments, image shift module 215 includes aligning or matching each vehicle rear-view image generated by rear camera 135B with each trailer rear-view image generated by rear camera 155A that were generated at the same point in time. The ability to dynamically adjust the size of buffer 185 to store a sufficient number of vehicle rear-view images for a given size of trailer allows for each vehicle rear-view image to be matched with the corresponding trailer rear-view image that was generated at the same point in time once that trailer rear-view image reaches the vehicle after the delay caused by the increased distance the image signals associated with the trailer rear-view images must travel to reach vehicle 105.

Image stitch module 220 is used to stitch together or combine each vehicle rear-view image with each respective trailer rear-view image that was generated at the same point in time to create a smooth, accurate, and cohesive image that is free of blind-spots created by the trailer obstruction or the delay in time for the trailer rear-view images to reach vehicle 105. In one or more embodiments, image stitch module 220 may combine images from two or more cameras to create a cohesive view, including a top view or a three-dimensional panoramic view from the perspective of vehicle 105.

In one or more embodiments, the stitched or combined image or video feed generated using image stitch module 220 may be displayed via output device 150 of GUI 140. In one or more embodiments, output device 150 may be a display screen of a head unit, a gauge cluster, or a rear-view mirror in vehicle 105. In one or more embodiments, output device 150 may be a panoramic view monitor.

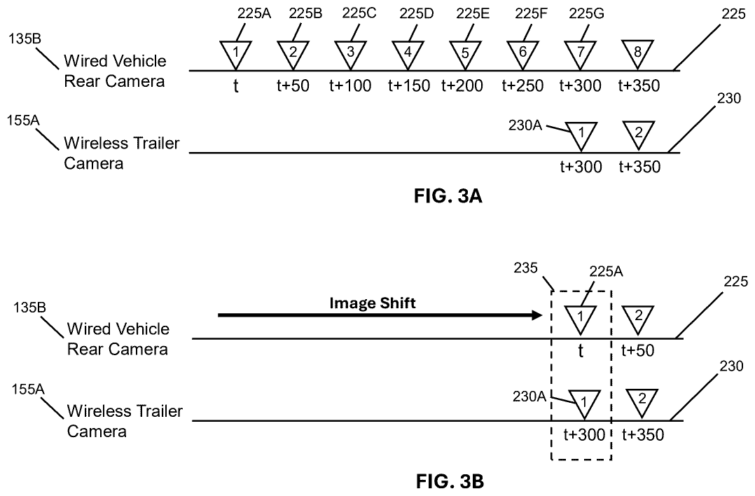

FIG. 3A illustrates execution of distance-based buffer size determination module 200, distance-based buffer size adjustment module 205, and image receipt module 210, according to one or more embodiments. In FIG. 3A, a first timeline 225 associated with vehicle rear-view images generated by rear camera 135B and a second timeline 230 associated with trailer rear-view images generated by rear camera 155A are shown, according to one or more embodiments. In the embodiment shown, both rear camera 135B and rear camera 155A have a frame rate of 20 frames per second (fps) such that each camera generates an image every 50 milliseconds (ms). In first timeline 225, a first image 225A is received at time “t”, a second image 225B is received at time “t+50 ms”, a third image 225C is received at time “t+100 ms”, a fourth image 225D is received at time “t+150 ms”, a fifth image 225E is received at time “t+200 ms”, a sixth image 225F is received at time “t+250 ms”, and a seventh image 225G is received at time “t+300 ms”. In second timeline 230, rear camera 155A generates respective images at the same points in time as rear camera 135B, however, as discussed above, because of the delay resulting from the distance between rear camera 155A and vehicle 105, the respective images generated by rear camera 155A are received later compared to the images generated by rear camera 135B. In second timeline 230, a first image 230A, which was generated at the same point in time as first image 225A, is not received until time “t+300 ms”. Thus, there exists a 300 ms delay between the point in time when the trailer rear-view images are generated by rear camera 155A and the point in time when the trailer rear-view images are received by vehicle 105.

FIG. 3A illustrates that image data 190 associated with seven vehicle rear-view images (i.e., first image 225A through seventh image 225G) and one trailer rear-view image (i.e., first image 230A) must be stored in buffer 185 before the images may be consecutively overwritten with new images so that respective images generated at the same points in time by rear camera 135B and rear camera 155A may be matched and combined. Thus, the size of buffer 185, or the number of buffers 185, is adjusted accordingly such that buffer 185 is configured to store image data 190 associated with at least seven images generated by rear camera 135B and at least one image generated by rear camera 155A.

FIG. 3B illustrates execution of image shift module 215, according to one or more embodiments. As shown in FIG. 3B, the vehicle rear-view images generated by rear camera 135B and stored in buffer 185, the size of which has been dynamically adjusted using distance-based buffer size determination module 200 and distance-based buffer size adjustment module 205, are shifted along first timeline 225 in order to align or match the vehicle rear-view images with the respective trailer rear-view images that were generated at the same point in time, but which were received at vehicle 105 at a later time due to the latency introduced into image capture system 100. For example, as shown in FIG. 3B, first image 225A through seventh image 225G have been shifted along first timeline 225 such that first image 225A is aligned with first image 230A, as shown by dashed box 235. Once respective images, such as first image 225A and first image 230A, have been aligned or matched, each set of respective images is stitched together or combined using image stitch module 220 to create a cohesive view that is unobstructed by trailer 110 and that is free of blind-spots and free of out-of-sync images.

As used herein, “shifted” refers to aligning or matching the vehicle rear-view images with the trailer rear-view images that were generated at the same point in time, but which were received at vehicle 105 at a later point in time due to the delay resulting from the additional distance that image signals associated with the transmission of the trailer rear-view images must travel to reach vehicle 105. In FIG. 3B, the “shift” of the vehicle rear-view images is illustrated in the literal sense as a physical shift along a timeline. In one or more embodiments, however, image shift module 215 does not include a literal physical shift of vehicle rear-view images, but rather includes a digital alignment or matching of the vehicle rear-view images and the trailer rear-view images that were generated at the same point in time.

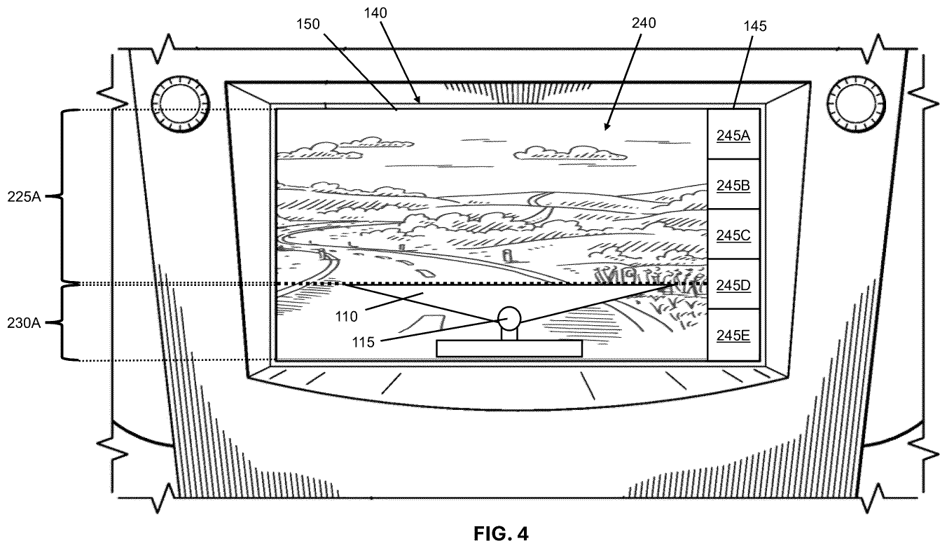

FIG. 4 illustrates output device 150 of GUI 140, according to one or more embodiments. In the embodiment shown, output device 150 is a display screen of a head unit in a dashboard or console of vehicle 105. A stitched image 240 generated using image stitch module 220 is displayed via output device 150. In one or more embodiments, stitched image 240 includes vehicle rear-view images generated by rear camera 135B combined with trailer rear-view images generated by rear camera 155A. In the embodiment shown, stitched image 240 includes first image 225A generated by rear camera 135B stitched together or combined with first image 230A generated by rear camera 155A. In one or more embodiments, by stitching together the images from rear camera 135B and rear camera 155A, stitched image 240 is configured to include a cumulative rear-view image that is unobstructed, or substantially unobstructed, by trailer 110 and which can be displayed to a user via GUI 140.

In one or more embodiments, image capture system 100 is not limited to combining rear-view images. In one or more embodiments, image capture system 100 is configured to combine images generated by various vehicle cameras 135 with images generated by various trailer cameras 155, which may include views in any direction from the perspective of vehicle 105 or trailer 110. In this way, a cohesive and unobstructed view of the environment surrounding vehicle 105 or trailer 110 in any direction may be generated and displayed via GUI 140.

In one or more embodiments, input device 145 of GUI 140 may include one or more buttons or selection icons 245 that may be selected by a user to change the image or camera angle displayed via output device 150. For example, in one or more embodiments, the selection icons 245 may include a selection icon 245A, a selection icon 245B, a selection icon 245C, a selection icon 245D, and a selection icon 245E. In one or more embodiments, selection of selection icon 245A may cause a rear-view camera angel to be displayed via output device 150. In one or more embodiments, selection of selection icon 245B may cause a front-view camera angel to be displayed via output device 150. In one or more embodiments, selection of selection icon 245C may cause a left-side-view camera angel to be displayed via output device 150. In one or more embodiments, selection of selection icon 245D may cause a right-side-view camera angel to be displayed via output device 150. In one or more embodiments, selection of selection icon 245E may cause a top-panoramic-view camera angel to be displayed via output device 150.

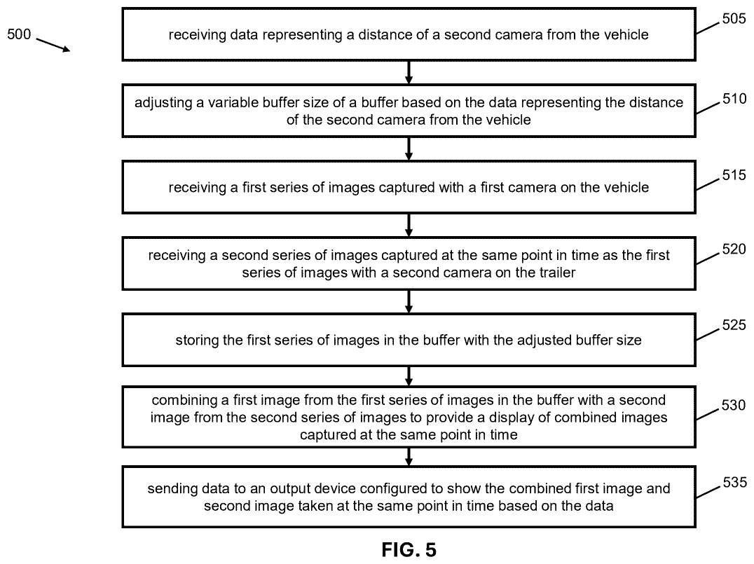

FIG. 5 illustrates a method 500 of utilizing a variable buffer size for a buffer in an image capture system with a first camera associated with a vehicle and a second camera associated with a trailer to compensate for latency due to a distance of the second camera from the vehicle, according to one or more embodiments. In one or more embodiments, the buffer may be buffer 185, the image capture system may be image capture system 100, the first camera may be rear camera 135B, the vehicle may be vehicle 105, the second camera may be rear camera 155A, and the trailer may be trailer 110.

In step 505 of method 500, CPU 125 is configured to receive data representing a distance of rear camera 155A from vehicle 105. In one or more embodiments, CPU 125 may receive an input associated with the dimensions of trailer 110 from input device 145 of GUI 140 or other input device. In one or more embodiments, a user of vehicle 105 or trailer 110 may manually input the dimensions of trailer 110, including the length of trailer 110, which are accessible to CPU 125, via input device 145 of GUI 140. In one or more embodiments, a user of vehicle 105 or trailer 110 may manually input the distance between rear camera 155A and vehicle 105, which is accessible to CPU 125, via input device 145 of GUI 140 or other input device. In one or more embodiments, the dimensions of trailer 110 may be automatically communicated to CPU 125 via wireless communication, such as WIFI, or via wired communication through electrical connections 120 when trailer 110 is connected to vehicle 105. In one or more embodiments, the dimensions of trailer 110 may be downloaded by CPU 125 via internet. In one or more embodiments, CPU 125 may utilize vehicle cameras 135 to obtain the dimensions of trailer 110 via object recognition programs or modules.

In step 510 of method 500, CPU 125 is configured to adjust a variable buffer size of buffer 185 based on the data representing the distance of rear camera 155A from vehicle 105. In one or more embodiments, adjustment of the size of buffer 185 includes increasing the number of buffers 185 stored in computer readable medium 180. In one or more embodiments, adjustment of the size of buffer 185 includes increasing the number of images or the amount of image data that is able to be stored in buffer 185.

In step 515 of method 500, CPU 125 is configured to receive a first series of images captured using rear camera 135B of vehicle 105. In one or more embodiments, rear camera 135B is in wired connection with CPU 125 and thus receipt of the first series of images from rear camera 135B may be in real-time. In one or more embodiments, step 515 is performed by executing image receipt module 210.

In step 520 of method 500, CPU 125 is configured to receive a second series of images captured using rear camera 155A of trailer 110 and captured at the same point in time as the first series of images captured using rear camera 135B. In one or more embodiments, rear camera 155A is a wireless camera positioned on trailer 110 and thus the point in time in which CPU 125 receives the second series of images may be delayed compared to the point in time in which CPU 125 receives the first series of images. In one or more embodiments, step 515 is performed by executing image receipt module 210.

In step 525 of method 500, CPU 125 is configured to store the first series of images in buffer 185 with the adjusted buffer size. In one or more embodiments, buffer 185 is located in computer readable medium 180.

In step 530 of method 500, CPU 125 is configured to combine a first image from the first series of images in buffer 185 with a second image from the second series of images to provide a display of combined images captured at the same point in time. In one or more embodiments, the first image is first image 225A and the second image is first image 230A. In one or more embodiments, the combined image may be stitched image 240.

In step 535 of method 500, CPU 125 is configured to send data to an output device configured to show the combined first image and second image taken at the same point in time based on the data. In one or more embodiments, the output device may be output device 150 of GUI 140.

As described herein, wireless camera systems can be used in conjunction with a trailer that is towed behind a vehicle in a towing configuration. The wireless camera system is configured to connect to the vehicle through an onboard wireless camera ECU. However, based on the length of the trailer, the latency of the wireless camera system changes. The length of the trailer significantly influences the latency of the camera system in both wired and wireless communication, but especially with respect to wireless communication. Longer trailers can introduce increased latency due to the additional distance the camera signals must travel. As a results, multi-camera perception tasks such as image stitching, where images from multiple cameras are combined to create a cohesive view, or image recognition have previously been difficult. Previously, the number of camera buffers in an ADAS ECU memory was fixed and therefore incapable of being changed based on the application. The present disclosure introduces systems and methods for adaptively managing camera buffer sizes in ADAS domain controller memory based on the length of the trailer being towed or based on the distance between the wireless camera positioned on the trailer and the vehicle. These systems and methods promote optimized memory usage and processing speed, reduced latency, and increased performance.

This disclosure introduces a system of utilizing a variable buffer size in an image capture system for a vehicle towing a trailer to compensate for latency due to a distance of the trailer from the vehicle, including: a first camera on the vehicle configured to capture a first series of images, a second camera on the trailer configured to capture a second series of images at the same point in time as the first series of images; an ECU having a buffer with a variable buffer size and configured to dynamically adjust the buffer size based on data representing a distance of the second camera from the vehicle, the ECU configured to: store the first series of images in the dynamically adjusted buffer; combine a first image from the first series of images in the buffer with a second image from the second series of images to provide a display of combined images captured at the same point in time; and configured to send data to an output device configured to show the combined first image and second image taken at the same point in time based on the data. In one or more embodiments, the system further includes an input device configured to receive the distance of the second camera from the vehicle. In one or more embodiments, the input device is a user input device configured to receive a manual input of the distance from a user. In one or more embodiments, the input device is configured to receive an automatically determined input based on data. In one or more embodiments, the ECU is configured to combine the first image and the second image for displaying at least a portion of a first image of the first at the same time as at least a portion of the first image. In one or more embodiments, the ECU is configured to combine the first image and the second image by stitching a portion of the first image with a portion of the second image. In one or more embodiments, the data representing the data representing the distance of the second camera from the vehicle is correlated with a wireless camera latency. In one or more embodiments, the output device is a display device in the vehicle. In one or more embodiments, the second camera on the trailer is a wireless camera and communicates with the ECU via a wireless protocol. In one or more embodiments, the vehicle comprises a wireless receiver configured to receive communications from the wireless camera on the trailer, the wireless receiver configured to communicate image data to the ECU for processing. In one or more embodiments, the distance of the second camera from the vehicle is a trailer length.

This disclosure also introduces a method of utilizing a variable buffer size in an image capture system with a first camera on a vehicle and a second camera on a trailer towed by the vehicle to compensate for latency due to a distance of the second camera from the vehicle, comprising: receiving data representing a distance of a second camera from the vehicle; adjusting a variable buffer size of a buffer based on the data representing a distance of the second camera from the vehicle; receiving a first series of images captured with a first camera on the vehicle; receiving a second series of images captured at the same point in time as the first series of images with a second camera on the trailer; storing the first series of images in the buffer with the adjusted buffer size; combining a first image from the first series of images in the buffer with a second image from the second series of images to provide a display of combined images captured at the same point in time; and sending data to an output device configured to show the combined first image and second image taken at the same point in time based on the data. In one or more embodiments, the distance of the second camera from the vehicle is a trailer length. In one or more embodiments, the method further includes receiving the distance of the second camera from the vehicle on a user input device on the vehicle. In one or more embodiments, the input device is a user input device configured to receive a manual input of the distance from a user. In one or more embodiments, the input device is configured to receive an automatically determined input based on data. In one or more embodiments, combining comprises stitching a portion of the first image with a portion of the second image. In one or more embodiments, the method further includes displaying the combined first image and second image on a display in the vehicle. In one or more embodiments, the second camera on the trailer is a wireless camera and communicates via a wireless protocol. In one or more embodiments, the method further includes receiving the second set of images via a wireless protocol at a wireless receiver from the wireless camera on the trailer.

It is understood that variations may be made in the foregoing without departing from the scope of the present disclosure.

In several embodiments, the elements and teachings of the various embodiments may be combined in whole or in part in some or all of the embodiments. In addition, one or more of the elements and teachings of the various embodiments may be omitted, at least in part, and/or combined, at least in part, with one or more of the other elements and teachings of the various embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several embodiments, while different steps, processes, and procedures are described as appearing as distinct acts, one or more of the steps, one or more of the processes, and/or one or more of the procedures may also be performed in different orders, simultaneously and/or sequentially. In several embodiments, the steps, processes, and/or procedures may be merged into one or more steps, processes and/or procedures.

In several embodiments, one or more of the operational steps in each embodiment may be omitted. Moreover, in some instances, some features of the present disclosure may be employed without a corresponding use of the other features. Moreover, one or more of the embodiments disclosed above, or variations thereof, may be combined in whole or in part with any one or more of the other embodiments described above, or variations thereof.

Although several embodiments have been described in detail above, the embodiments described are illustrative only and are not limiting, and those skilled in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A system of utilizing a variable buffer size in an image capture system for a vehicle towing a trailer to compensate for latency due to a distance of the trailer from the vehicle, comprising:
a first camera on the vehicle configured to capture a first series of images,
a second camera on the trailer configured to capture a second series of images at the same point in time as the first series of images;
a CPU having a buffer with a variable buffer size and configured to dynamically adjust the buffer size based on data representing a distance of the second camera from the vehicle, the CPU configured to:
store the first series of images in the dynamically adjusted buffer;
combine a first image from the first series of images in the buffer with a second image from the second series of images to provide a display of combined images captured at the same point in time; and
send data to an output device configured to show the combined first image and second image taken at the same point in time based on the data.

2. The system of claim 1, comprising an input device configured to receive the distance of the second camera from the vehicle.

3. The system of claim 2, wherein the input device is a user input device configured to receive a manual input of the distance from a user.

4. The system of claim 2, wherein the input device is configured to receive an automatically determined input based on data.

5. The system of claim 1, wherein the CPU is configured to combine the first image and the second image for displaying at least a portion of a first image of the first at the same time as at least a portion of the first image.

6. The system of claim 5, wherein the CPU is configured to combine the first image and the second image by stitching a portion of the first image with a portion of the second image.

7. The system of claim 1, wherein the data representing the data representing the distance of the second camera from the vehicle is correlated with a wireless camera latency.

8. The system of claim 1, wherein the output device is a display device in the vehicle.

9. The system of claim 1, wherein the second camera on the trailer is a wireless camera and communicates with the CPU via a wireless protocol.

10. The system of claim 9, wherein the vehicle comprises a wireless receiver configured to receive communications from the wireless camera on the trailer, the wireless receiver configured to communicate image data to the CPU for processing.

11. The system of claim 1, wherein the distance of the second camera from the vehicle is a trailer length.

12. A method of utilizing a variable buffer size in an image capture system with a first camera on a vehicle and a second camera on a trailer towed by the vehicle to compensate for latency due to a distance of the second camera from the vehicle, comprising:
receiving data representing a distance of a second camera from the vehicle;
adjusting a variable buffer size of a buffer based on the data representing a distance of the second camera from the vehicle;
receiving a first series of images captured with a first camera on the vehicle;
receiving a second series of images captured at the same point in time as the first series of images with a second camera on the trailer;
storing the first series of images in the buffer with the adjusted buffer size;
combining a first image from the first series of images in the buffer with a second image from the second series of images to provide a display of combined images captured at the same point in time; and
sending data to an output device configured to show the combined first image and second image taken at the same point in time based on the data.

13. The method of claim 12, wherein the distance of the second camera from the vehicle is a trailer length.

14. The method of claim 12, comprising receiving the distance of the second camera from the vehicle on a user input device on the vehicle.

15. The method of claim 14, wherein the input device is a user input device configured to receive a manual input of the distance from a user.

16. The method of claim 14, wherein the input device is configured to receive an automatically determined input based on data.

17. The method of claim 12, wherein combining comprises stitching a portion of the first image with a portion of the second image.

18. The method of claim 12, comprising, displaying the combined first image and second image on a display in the vehicle.

19. The method of claim 12, wherein the second camera on the trailer is a wireless camera and communicates via a wireless protocol.

20. The method of claim 19, comprising receiving the second set of images via a wireless protocol at a wireless receiver from the wireless camera on the trailer.
